(19) United States
(12) Patent Application Publication
(10) Pub. No.: US 2007/0058033 A1
(43) Pub. Date: Mar. 15, 2007

(54) Multimedia apparatus and method for automated selection of preset audio/video settings in accordance with a selected signal source

(75) Inventors: Chian-Chuan Tsai, Taipei City (TW); Show-Nan Chung, Taipei City (TW); Der-Chuan Ouyang, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/495,514

(22) Filed: Jul. 31, 2006

(30) Foreign Application Priority Data
Aug. 1, 2005 (TW) 094126037

(51) Int. Cl. H04N 7/14

(52) U.S. Cl. 348/14.05

(57) ABSTRACT

A multimedia apparatus includes a memory unit for recording a plurality of preset audio/video configurations corresponding to a plurality of signal sources, a control module electrically connected to the memory unit for automatically selecting a desired configuration from the plurality of preset audio/video configurations according to a selected signal source, and a processing module electrically connected to the control module for adjusting the multimedia data transmitted by the selected signal source according to the desired configuration.

### BACKGROUND OF THE INVENTION

1. Field of the Invention

The present invention relates to multimedia apparatus and control methods, more particularly, to an apparatus and control method for automatically selecting a preset audio/video setting according to a user signal source.

2. Description of the Prior Art

With recent advancements in multimedia technology, the various functions and features found in multimedia apparatuses have greatly improved. Televisions, for example, possess a wide availability of selectable channels and programs. They also typically have an excess of electronic devices connected, including DVD players and gaming systems. Users are able to select a desired channel or directly switch to an outside electronic device by receiving an AV-signal from its AV terminal. The selected signal is then transferred into frames and displayed onto a screen. Many different channels are selectable by the user, with each channel possessing a different audio/visual focus. For example, a music channel will focus more on musical effects and sound quality, while a sports channel may focus more on the clarity of images. Typically, when users switch from one channel to another, the audio/video control parameters usually have to be re-adjusted in order to obtain a preferred audio/video setting for the selected channel. This consequently makes it very inconvenient for users to continually watch television in a preferred manner.

### SUMMARY OF THE INVENTION

It is therefore one of the objectives of the claimed invention to provide a multimedia apparatus and a control method capable of automatically selecting different predetermined audio/video settings according to a user signal source in order to solve the above-mentioned problem.

According to the claimed invention, a multimedia apparatus is disclosed. The multimedia apparatus includes a storage unit for recording a plurality of predetermined settings corresponding to a plurality of signal sources; a control module, electrically connected to the storage unit for choosing a desired predetermined setting from the plurality of predetermined setting values according to a selected signal source; and a processing module, electrically connected to the control module for adjusting multimedia data delivered by the selected signal source according to the desired predetermined setting value.

According to the claimed invention, a control method is further disclosed. The control method includes storing a plurality of predetermined setting values corresponding to a plurality of signal sources; choosing a desired predetermined setting value from the plurality of predetermined setting values according to a selected signal source; and adjusting multimedia data delivered by the selected signal source according to the desired predetermined setting value.

Through the above multimedia apparatus, users are capable of predetermining desired settings (or presetting) for audio/video configurations for each audio/video source or channel through a control module, and store this preset configuration into a storage unit. When a user selects an audio/video source or channel, the multimedia apparatus is capable of automatically selecting the desired preset video settings and preset audio settings through the processing module. In this way, it is unnecessary for users to manually adjust the audio/video settings of the multimedia apparatus when switching between different audio/video sources.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of the multimedia apparatus 10 according to a first embodiment of the present invention.

FIG. 2 is a diagram of a TV 110 utilizing the multimedia apparatus 10 illustrated in FIG. 1 with other peripheral devices.

FIG. 3 is a correspondence table 400 for channels and audio/video setting values recorded in the storage unit 60 illustrated in FIG. 1.

FIG. 4 is a flowchart illustrating the control method of multimedia apparatus 10 shown in FIG. 1.

### DETAILED DESCRIPTION

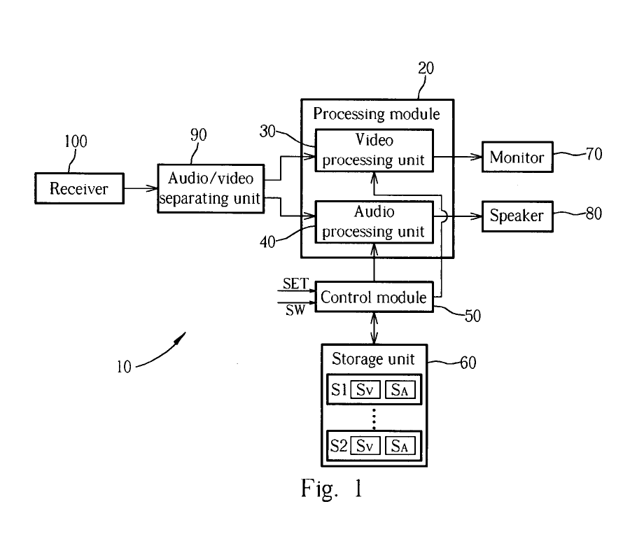

FIG. 1 illustrates a block diagram of the multimedia apparatus 10 according to a first embodiment of the present invention. As shown in FIG. 1, the multimedia apparatus 10 includes a receiver 100, an audio/video separating unit 90, a processing module 20, a control module 50, a storage unit 60, a monitor 70, and a speaker 80. The processing module 20 further includes a video processing unit 30 and an audio processing unit 40. The following description will further detail the operation of the multimedia apparatus 10.

The process begins with the receiver 100 receiving multimedia data from a selected signal source (Digital TV signal, etc.), and delivering the multimedia data to the video/audio separating unit 90. Please note that in this embodiment, the multimedia apparatus 10 possesses only one receiver 100, however, in further embodiments the multimedia apparatus 10 may include a plurality of receivers corresponding to different signal sources. The video/audio separating unit 90 continues with separating the received multimedia data into an individual video signal and audio signal, and then delivers the respective signals to the video processing unit 30 and audio processing unit 40 of the processing module 20. The video processing unit 30 and the audio processing unit 40 then act to adjust each respective signal according to the desired preset (predetermined) settings received from the control module 50. The adjusted video and audio signals are then delivered by the processing module 20 to the monitor 70 and the speaker 80 for viewing by the user.

The control module 50 of the multimedia apparatus 10 is electrically connected to the processing module 20 and the storage unit 60, where the storage unit 60 records and stores a plurality of predetermined setting values S₁˜Sₙ corresponding to a plurality of signal sources. Each setting value includes a predetermined video setting S_{V} and a predetermined audio setting S_{A}. Additionally, the control module 50 chooses a desired predetermined setting value from the plurality of predetermined setting values S₁˜Sₙ according to the user selected signal source. Once a desired setting value is selected, the control module 50 then inputs this predetermined setting into the video processing unit 30 and the audio processing unit 40 of the processing module 20. The video processing unit 30 and the audio processing unit 40 then act to adjust the respective video and audio signals according to the video predetermined setting value S_{V} and the audio predetermined setting value S_{A}.

Also worth noting is that the plurality of predetermined setting values S₁˜Sₙ recorded in the storage unit 60 can be updated through the control module 50. To do this, users can select the setting signal (SET) of the control module 50 to enter a setting mode. The control module 50 would then update the saved data in the storage unit 60 in accordance with the audio/video settings entered by the user. In this fashion, users are capable of setting desired preset audio/video values for the multimedia apparatus 10 for use with different audio/video sources or channels. Also, when a user switches from a current signal source to another signal source, the control module 50 receives a switching signal SW and automatically selects the desired preset audio/visual setting corresponding to the selected signal source. The desired preset value is then inputted into the processing module 20 to adjust the multimedia data outputted by the monitor 70 and the speaker 80. In this manner, the multimedia apparatus 10 of this embodiment is capable of automatically selecting a desired predetermined video setting S_{V} and predetermined audio setting S_{A} upon the switching of a signal source. This allows the multimedia apparatus 10 to constantly and consistently have a preferred audio and video setting while playing various forms of multimedia data.

Please note that the storage unit 60 in this embodiment is designed for portability, and as such, the desired preset values established by the user is not limited to use in a single machine. That is, users can take the storage unit 60 anywhere and use it in another machine consisting of the same multimedia apparatus 10, without having to reprogram the audio/video preset values. The storage unit 60 may consist of being a portable hard disk, or even a memory card (such as a CF card). Additionally, the type of memory (DRAM etc.) does not in any way limit the storage unit 60. The storage unit may be of DRAM type to save costs, but at this time if the multimedia apparatus 10 is turned off, the power system has to supply power to the memory to maintain the saved data.

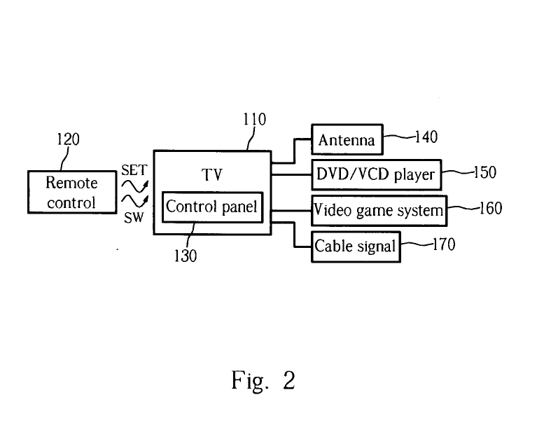

FIG. 2 shows an alternate embodiment of the multimedia apparatus 10 of FIG. 1 being incorporated into TV 110 through an internal circuit of the TV 110. The TV 110 applies the multimedia apparatus 10 in conjunction with the other peripheral devices connected. The TV 110 further includes a control panel 130, and a remote control 120 for use as input devices so users can enter a setting signal SET and a switching signal SW as previously described. Additionally, the input devices may also be used for other functions, such as TV channel selection, audio/video settings (for example: brightness, contrast, stereo, closed captioning etc.), power, and other typical functions. In this embodiment, the TV 110 is also connected to other signal sources, including an antenna 140, a DVD/VCD player 150, a video game system 160, and a cable signal 170. In this embodiment, the signal sources for the TV 110 may comprise of the different channels of the cable signal 170 or antenna 140, video and audio signals from the DVD/VCD player 150, or the audio/visual signals from the video game system 160.

Users can utilize the control panel 130 or the remote control 120 to select preferred audio/video settings in advance for each specified TV channel or peripheral device. The multimedia apparatus 10 in the TV 110 will store this setting into the storage unit 60, and recall this setting when the specific TV channel or device is selected for viewing. Please note that it is also possible to have the predetermined settings in the storage unit 60 set in advance from the manufacturing company. For example, modes such as concert mode, movie mode and theater mode may be saved in advance within the storage unit 60 for relevant programs. A user would then just have to select which mode corresponds to which channel or device. For some (or many) channels or devices, it may be unnecessary to even set a preferred audio/video mode as a default setting can be utilized.

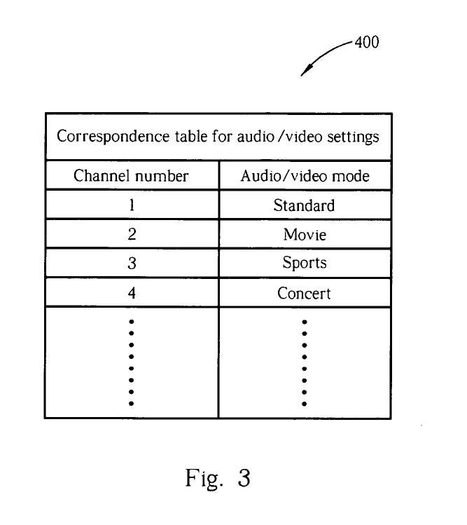

Referring to FIG. 3, a correspondence table 400 for audio/video settings stored in the storage unit 60 of FIG. 1. The column titled “channel number” in the correspondence table 400 can be used to indicate television channels or other inputs from peripheral devices. Every channel listed in the correspondence table 400 relates to a specific audio/video mode, with each corresponding audio/video mode being user programmable. For example, channel 1 can be programmed to use a standard mode, while channel 2 can utilize a movie mode, channel 3 a sports mode, channel 4 a concert mode, and so forth. A user can personally select the desired audio/visual mode to correspond with a specific channel to match their personal preference.

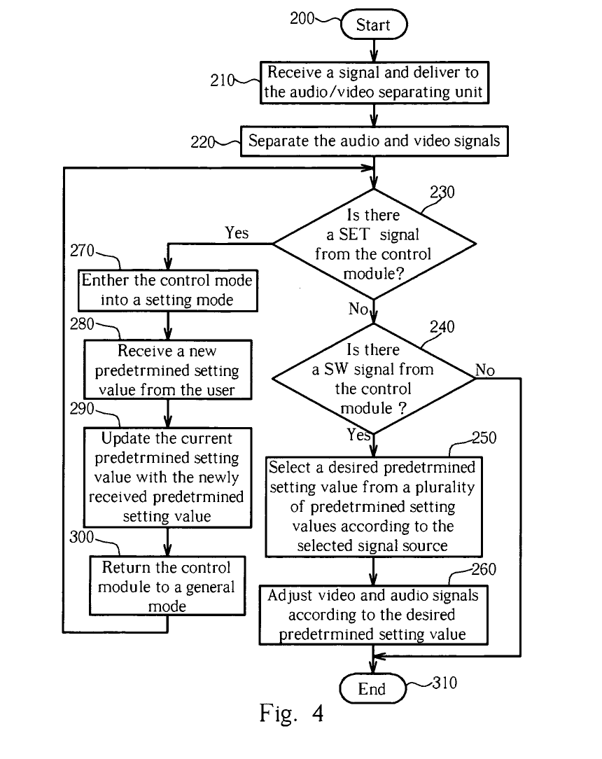

FIG. 4 is a flowchart illustrating the process method of the multimedia apparatus 10 as described in FIG. 1. Using this process method, it is possible to choose a preset video setting S_{V} and a preset audio setting S_{A} to achieve a desired audio/video configuration for a specific signal source. In this fashion, the multimedia apparatus 10 will automatically select the preferred audio/video setting while a user is viewing various forms of multimedia data. The detailed process steps of the flowchart of FIG. 4 are described in the following:
Step 200: start;
Step 210: receive a signal from the signal source by the receiver 100, and deliver the signal to the audio/video separating unit 90;
Step 220: separate the audio and video signals with the audio/video separating unit 90, and send the respective signals to the audio processing unit 40 and video processing unit 30 of the processing module 20;
Step 230: determine if a setting signal SET is received by the control module 50, if YES, then go to step 270, if NO, go to step 240;
Step 240: determine if a switching signal SW is received by the control module 50, if YES, go to step 250, if NO go to step 310;
Step 250: utilize the control module 50 to select the desired preset value from a plurality of preset values S₁˜Sₙ in the storage unit 60 according to the selected signal source;
Step 260: utilize the video processing unit 30 and the audio processing unit 40 to adjust the respective video and audio signals in accordance with the desired predetermined setting value, and deliver the visual signals to the monitor 70 and the audio signals to the speaker 80;
Step 270: enter the control module 50 into a setting mode;
Step 280: receive a new predetermined setting value from the user through the control panel 130 or the remote control 120;
Step 290: update the current predetermined setting with the newly received predetermined setting value;
Step 300: return the control module to a general mode, and jump to step 230;
Step 310: end.

Utilizing the present invention, the described multimedia apparatus 10 can automatically choose a preferred video preset value S_{V} and a preferred audio preset value S_{A} according to a user specifed signal sources. Therefore, users do not have to manually adjust audio/video settings to a preferred setting when a different input signal source is chosen. This results in a much more convenient and enjoyable overall viewing experience.

Although the above embodiment describes a processing module 20 comprising a video processing unit 30 and an audio processing unit 40, the present invention is not limited to solely deal with audio and video information formats. The processing module 20 may also be configured to deal with a single information format. For example, a multimedia apparatus applied to a sound device would only include the audio processing unit 40. The operational principles for this case would be similar to that of the multimedia apparatus 10 discussed above, therefore it is not necessary to further divulge into its details.
Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multimedia apparatus for automatically selecting a preset audio/video configuration according to a selected signal source, the multimedia apparatus comprising:
a storage unit for recording a plurality of predetermined setting values corresponding to a plurality of signal sources;
a control module, electrically connected to the storage unit, for choosing a desired predetermined setting value from the plurality of predetermined setting values according to the selected signal source; and
a processing module, electrically connected to the control module, for adjusting multimedia data delivered by the selected signal source according to the desired predetermined setting value.

2. The multimedia apparatus of claim 1, wherein each predetermined setting value comprises a predetermined video setting value and a predetermined audio setting value, and the processing module comprises a video processing unit and an audio processing unit, the video processing unit adjusts the multimedia data according to the predetermined video setting value and the audio processing unit adjusts the multimedia data according to the predetermined audio setting value.

3. The multimedia apparatus of claim 1, wherein each predetermined setting value comprises a predetermined audio setting value, and the processing module comprises an audio processing module for adjusting the multimedia data according to the predetermined audio setting value.

4. The multimedia apparatus of claim 1, wherein the plurality of signal sources comprise a plurality of television channels.

5. The multimedia apparatus of claim 1, wherein the storage unit is a portable storage unit.

6. The multimedia apparatus of claim 1, wherein the control module further receives a setting signal to enable a setting mode, the control module updates the plurality of predetermined setting values recorded in the storage unit according to an input of audio/video setting values.

7. A control method for automatically selecting preset audio/video setting according to a selected signal source, the control method comprising:
recording a plurality of predetermined setting values corresponding to a plurality of signal sources;
selecting a desired predetermined setting value from the plurality of predetermined setting values according to the selected signal source; and
adjusting multimedia data delivered by the selected signal source according to the desired predetermined setting value.

8. The control method of claim 7, wherein each predetermined setting value comprises a predetermined video setting value and a predetermined audio setting value, and the step of adjusting multimedia data delivered by the selected signal source comprises adjusting multimedia data according to the predetermined video setting value or the predetermined audio setting value of the desired predetermined setting value.

9. The control method of claim 7, wherein the plurality of signal sources comprises of a plurality of television channels.

10. The control method of claim 7, wherein the step of recording a plurality of predetermined setting values corresponding to a plurality of signal sources further comprises:
recording the plurality of predetermined setting values in a portable storage unit.

11. The control method of claim 7 further comprising:
receiving a setting signal to enable a setting mode, and updating the plurality of predetermined setting values recorded in a storage unit according to an input of audio/video setting values.
